(19) United States
(12) Patent Application Publication
(10) Pub. No.: US 2016/0146040 A1
(43) Pub. Date: May 26, 2016

(54) Alternating Vane Asymmetry

(71) Applicant: United Technologies Corporation, Farmington, CT (US)

(72) Inventors: Alex J. Simpson, Tolland, CT (US); Bryan P. Dube, Columbia, CT (US); John E. Paul, Portland, CT (US)

(21) Appl. No.: 14/933,497

(22) Filed: Nov. 5, 2015

Related U.S. Application Data
(60) Provisional application No. 62/084,386, filed on Nov. 25, 2014.

(51) Int. Cl. F01D 25/06; F04D 29/32; F01D 5/02; F01D 9/04

(52) U.S. Cl. CPC F01D 25/06; F01D 9/041; F04D 29/321; F01D 5/02; F05D 2220/32; F05D 2240/12; F05D 2240/24; F05D 2260/961

(57) ABSTRACT

A vane assembly for a gas turbine engine may include a plurality of vanes being arranged in vane groupings symmetrically spaced circumferentially from each other. Each vane grouping may include at least a first and a second vane. The at least first and second vanes may be spaced from each other at a first pitch. Each vane grouping may be spaced from each other at a second pitch. The first pitch may be dissimilar from the second pitch.

### CROSS-REFERENCE TO RELATED APPLICATIONS

This application is a non-provisional patent application claiming the 35 U.S.C. 119(e) benefit of U.S. Provisional Patent Application No. 62/084,386 filed on Nov. 25, 2014.

### STATEMENT OF GOVERNMENT INTEREST

This invention was made with Government support under contract number FA8650-09-D-2923-0021 awarded by the United States Air Force. The Government has certain rights in the invention.

### TECHNICAL FIELD

The subject matter of the present disclosure relates generally to gas turbine engines and, more particularly, relates to vanes for such gas turbine engines.

### BACKGROUND

Gas turbine engines generally include a compressor, a combustor, and a turbine arranged in serial flow combination. Air enters the engine and is pressurized in the compressor. The pressurized air is then mixed with fuel in the combustor. Hot combustion gases are generated when the mixture of pressurized air and fuel are subsequently burned in the combustor. The hot combustion gases flow downstream to the turbine, which extracts energy from the combustion gases to drive the compressor.

The turbine may include multiple stages with each stage including a row of stationary vanes and a row of rotating blades that extend from a turbine disk. The row of stationary vanes direct the hot combustion gases to flow at a preferred angle toward the row of rotating blades. In some gas turbine engines, the vanes are evenly spaced circumferentially from each other around the flow path annulus. Pressure distortion may be produced on the rotating blades each time a blade passes a stationary vane causing blade vibration. For example, each time a blade passes successive vanes a pressure fluctuation is produced on the blade such that if the product of the number of pressure disturbances per revolution and the rotational speed of the blade line up with a fundamental frequency of the blade, then a vibratory response leading to potential high-cycle fatigue failure may result.

In efforts to reduce the strength of the excitation to the blades at a particular frequency and, thus, the potential for high-cycle fatigue failure, some gas turbine engines utilized an asymmetric pattern of vanes. For example, a uniform spacing between a first set of vanes (e.g. 10 evenly spaced vanes) may be implemented around approximately half of the flow path annulus while a different uniform spacing between a second set of vanes (e.g. 12 evenly spaced vanes) is implemented over the other approximately half flow path annulus. While generally effective, the similarity in spacing in each half of the asymmetric spacing of vanes relative to an original symmetric spacing produces the result of excitation frequencies that are generally close to the original frequency. This asymmetric configuration also requires two sets of tooling for each half side of vanes because of the different uniform spacing in each half side, which increases production costs.

### SUMMARY

In accordance with an aspect of the disclosure, a vane assembly for a gas turbine engine is provided. The vane assembly may include a plurality of vanes being arranged in vane groupings symmetrically spaced circumferentially from each other. Each vane grouping may include at least a first and a second vane. The at least first and second vanes may be spaced from each other at a first pitch. Each vane grouping may be spaced from each other at a second pitch. The first pitch may be dissimilar from the second pitch.

In accordance with another aspect of the disclosure, the first pitch may be less than the second pitch.

In accordance with yet another aspect of the disclosure, the at least first vane may have an airfoil shape that is dissimilar to an airfoil shape of the at least second vane.

In accordance with still yet another aspect of the disclosure, the at least first vane may be offset axially downstream from the at least second vane.

In further accordance with another aspect of the disclosure, each vane grouping may further include at least a third vane. The at least third vane may be spaced from the at least second vane at a third pitch. The third pitch may be dissimilar from both the first pitch and the second pitch.

In accordance with another aspect of the disclosure, a gas turbine engine is provided. The gas turbine engine may include a combustor downstream of a compressor and a turbine downstream of the combustor. One of the compressor and the turbine may include a vane assembly. The vane assembly may include a plurality of vanes being arranged in vane groupings symmetrically spaced circumferentially from each other. Each vane grouping may include at least a first and a second vane. The at least first and second vanes may be spaced from each other at a first pitch. Each vane grouping may be spaced from each other at a second pitch. The first pitch may be dissimilar from the second pitch.

In accordance with still another aspect of the disclosure, each vane grouping may further include at least a third vane and a fourth vane. The at least third vane may be spaced from the at least second vane at a third pitch. The third pitch may be dissimilar from both the first pitch and the second pitch. The at least fourth vane may be spaced from the at least third vane at a fourth pitch. The fourth pitch being dissimilar from the first through third pitches.

In accordance with yet another aspect of the disclosure, the compressor may include a plurality of blades associated with the vane assembly. The at least first vane may be capable of exciting the plurality of blades at a first frequency. The at least second vane may be capable of exciting the plurality of blades at a second frequency. The first frequency may be dissimilar from the second frequency.

In accordance with still yet another aspect of the disclosure, the turbine may include a plurality of blades associated with the vane assembly. The at least first vane may be capable of exciting the plurality of blades at a first frequency. The at least second vane may be capable of exciting the plurality of blades at a second frequency. The first frequency may be dissimilar from the second frequency.

In accordance with still another aspect of the disclosure, a method of reducing vibration on at least one blade in a gas turbine engine is provided. The method entails providing a plurality of vanes. Another step may be arranging the plurality of vanes in vane groupings symmetrically spaced circumferentially from each other. Yet another step may be arranging each vane in the vane grouping so that the at least one blade is capable of being excited at different frequencies when rotating past each vane, respectively.

In accordance with still yet another aspect of the disclosure, the method may include each vane in the vane groupings having a similar airfoil shapes.

In accordance with an even further aspect of the disclosure, the method may further include the step of arranging each vane with respect to an adjacent vane by one of pitch separating the vanes, angle orientation of the vanes, and axial alignment of the vanes.

In accordance with a yet an even further aspect of the disclosure, the method may include each vane in the vane grouping having a dissimilar airfoil shape.

In further accordance with another aspect of the disclosure, the method may further include the step of arranging the vane grouping into vane doublets having a first vane and a second vane.

In further accordance with yet another aspect of the disclosure, the method may include the step of arranging the first vane to be capable of exciting the at least one blade at a first frequency and arranging the second vane to be capable of exciting the at least one blade at a second frequency that is dissimilar to the first frequency.

In further accordance with still yet another aspect of the disclosure, the first frequency and the second frequency may be capable of exciting the at least one blade at a first and a second excitation magnitude, respectively, that are less than an excitation magnitude of a vane assembly having evenly spaced singlet vanes.

In further accordance with an even further aspect of the disclosure, the at least one blade may be capable of being alternately excited at the first frequency and the second frequency within a revolution to match a peak vibratory stress amplitude with an average vibratory stress amplitude.

Other aspects and features of the disclosed systems and methods will be appreciated from reading the attached detailed description in conjunction with the included drawing figures. Moreover, selected aspects and features of one example embodiment may be combined with various selected aspects and features of other example embodiments.

### BRIEF DESCRIPTION OF THE DRAWINGS

For further understanding of the disclosed concepts and embodiments, reference may be made to the following detailed description, read in connection with the drawings, wherein like elements are numbered alike, and in which:

FIG. 1 is a side view of a gas turbine engine with portions sectioned and broken away to show details of the present disclosure;

FIG. 2 is a schematic front view of one stage of a plurality of vanes of the gas turbine engine of FIG. 1, constructed in accordance with the teachings of this disclosure;

FIG. 3 is an end view of two sets of vane groupings in vane doublets of FIG. 2, constructed in accordance with the teachings of this disclosure;

FIG. 4 is an end view of an alternative embodiment of the two sets of vane groupings in FIG. 3, constructed in accordance with the teachings of this disclosure;

FIG. 5 is an end view of another alternative embodiment of two sets of vane groupings in vane doublets of FIG. 2, constructed in accordance with the teachings of this disclosure;

FIG. 6 is an end view of an alternative embodiment of the two sets of vane groupings of FIG. 5, constructed in accordance with the teachings of this disclosure;

FIG. 7 is an end view of two sets of vane groupings in vane triplets, constructed in accordance with the teachings of this disclosure;

FIG. 8 is an end view of two sets of vane groupings in vane quadruplets, constructed in accordance with the teachings of this disclosure; and

FIG. 9 is a flowchart illustrating a sample sequence of steps which may be practiced in accordance with the teachings of this disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

Throughout this specification the terms “downstream” and “upstream” are used with reference to the general direction of gas flow through the engine and the terms “axial”, “radial” and “circumferential” are generally used with respect to the longitudinal central engine axis.

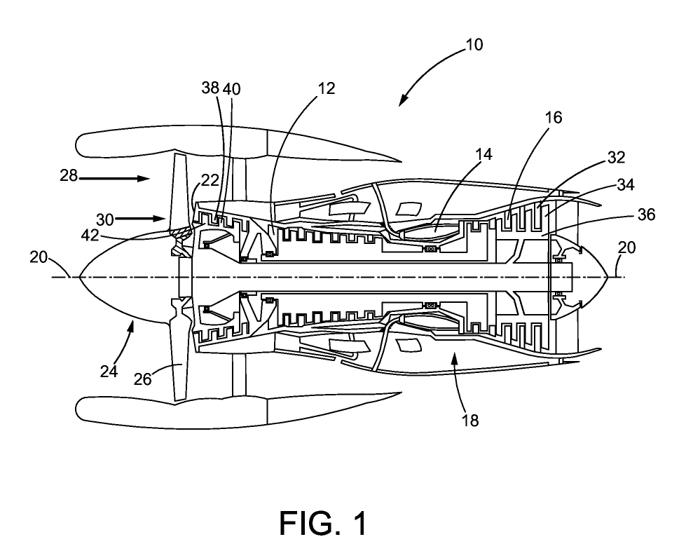

Referring now to FIG. 1, a gas turbine engine constructed in accordance with the present disclosure is generally referred to by reference numeral 10. The gas turbine engine 10 includes a compressor section 12, a combustor 14 and a turbine section 16. The serial combination of the compressor section 12, the combustor 14 and the turbine section 16 is commonly referred to as a core engine 18. The engine 10 is circumscribed about a longitudinal central axis 20.

Air enters the compressor section 12 at the compressor inlet 22 and is pressurized. The pressurized air then enters the combustor 14. In the combustor 14, the air mixes with jet fuel and is burned, generating hot combustion gases that flow downstream to the turbine section 16. The turbine section 16 extracts energy from the hot combustion gases to drive the compressor section 12 and a fan 24, which includes a plurality of airfoils 26 (two airfoils shown in FIG. 1). As the turbine section 16 drives the fan 24, the airfoils 26 rotate so as to take in more ambient air. This process accelerates the ambient air 28 to provide the majority of the useful thrust produced by the engine 10. Generally, in some modern gas turbine engines, the fan 24 has a much greater diameter than the core engine 18. Because of this, the ambient air flow 28 through the fan 24 can be 5-10 times higher, or more, than the core air flow 30 through the core engine 18. The ratio of flow through the fan 24 relative to flow through the core engine 18 is known as the bypass ratio.

The turbine section 16 may include multiple stages with each stage including a plurality of stationary vanes 32 and a plurality of rotating blades 34 that extend from a turbine hub 36. Similarly, the compressor section 12 may include multiple stages with each stage including a plurality of stationary vanes 38 (stators) and a plurality of rotating blades 40 (rotors) that extend from a rotor disk 42. The plurality of stationary vanes 32 of the turbine section 16 and the plurality of stationary vanes 38 of the compressor section 12 may be similarly arranged and, as such, the below description of the arrangement of the plurality of stationary vanes 32 of the turbine section 16 may also apply to the plurality of stationary vanes 38 of the compressor section 12.

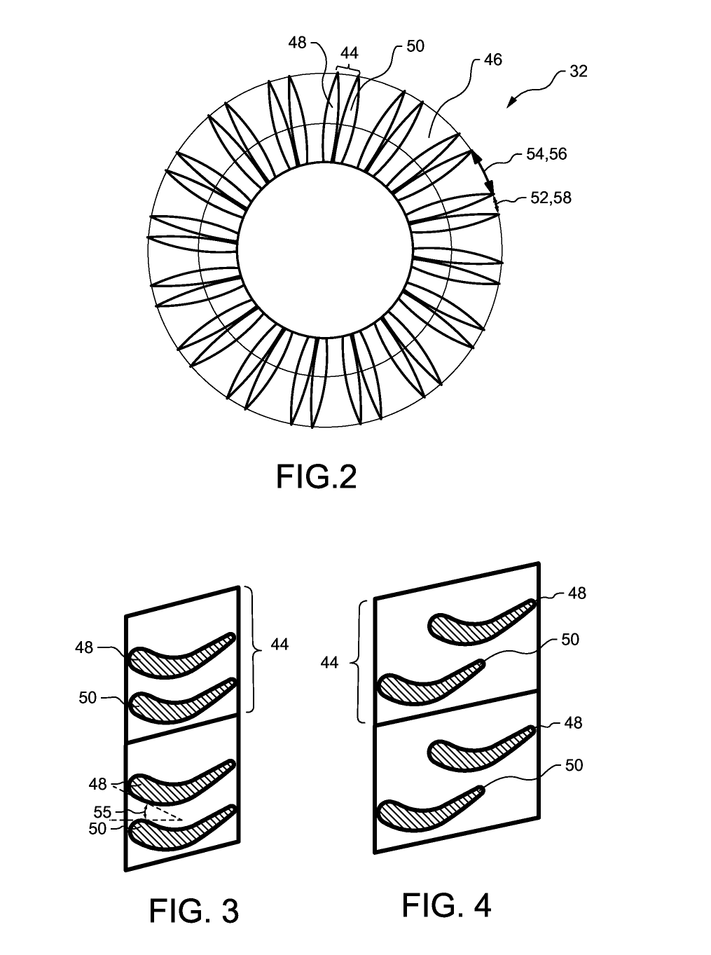

As best seen in FIG. 2, the plurality of stationary vanes 32 may be arranged in vane groupings 44 such as, for example, in doublets. The vane groupings 44 may also be arranged in vane triplets, vane quadruplets, or other groupings. Each of the vane groupings 44 may be evenly spaced circumferentially from each other around a flowpath annulus 46. As shown in FIG. 3, each vane of the plurality of vanes 32 may have an airfoil shape. More specifically, in the embodiment illustrated in FIG. 3, each vane grouping 44 may include a first vane 48 and a second vane 50. The second vane 50 may have a similar airfoil shape as the first vane 48. Referring to FIG. 2, it is shown that the first vane 48 and the second vane 50 may be separated from each other at a first pitch 52. Likewise, each vane grouping 44 may be separated from each other at a second pitch 54 that is dissimilar from the first pitch 52. The first pitch 52 may be less than the second pitch 54. Moreover, the first vane 48 and the second vane 50 may be arranged with respect to each other at a first angle 55.

Due to the first pitch 52 being dissimilar to the second pitch 54, during engine 10 operation, the blades 34 may be excited at a first frequency 56 each time they pass the first vanes 48 and may be excited at a second frequency 58, which may be dissimilar to the first frequency 56, each time they pass the second vanes 50. Because of this alternating pattern, the blades 34 are excited at a different frequency at every other vane 48, 50, thereby evenly distributing the excitation on the blades 34 within a revolution to approximately match a peak vibratory stress amplitude with an average vibratory stress amplitude. In particular, the first frequency 56 may be approximately half an original symmetric frequency of a prior art vane assembly with evenly spaced singlet vanes. On the other hand, the second frequency 58 may be approximately double the original symmetric frequency of the prior art vane assembly with evenly spaced singlet vanes. As a result, the first frequency 56 and the second frequency 58 may excite the rotating blades 34 at a first and a second excitation magnitude, respectively, that are less than an excitation magnitude found with the prior art vane assembly with evenly spaced singlet vanes.

In a similar manner, the first angle 55 may be arranged such that, during engine 10 operation, the blades 34 may be excited at the first frequency 56 each time they pass the first vanes 48 and may be excited at the second frequency 58, which may be dissimilar to the first frequency 56, each time they pass the second vanes 50.

In an alternative embodiment depicted in FIG. 4, the vane groupings 44 may be arranged such that the first vane 48 is offset axially downstream from the second vane 50. In this arrangement, during engine 10 operation, the blades 34 may also be excited at the first frequency 56 each time they pass the first vanes 48 and may be excited at the second frequency 58, which may be dissimilar to the first frequency 56, each time they pass the second vanes 50.

It is also within the scope of the disclosure and appended claims that the first vane 48 and the second vane 50 may be patterned in various combinations in regards to the above described pitch, angle, and axially offset alignment of the vanes 48, 50 in order that the blades 34 may be excited, during engine 10 operation, at the first frequency 56 each time they pass the first vanes 48 and may be excited at the second frequency 58, which may be dissimilar to the first frequency 56, each time they pass the second vanes 50.

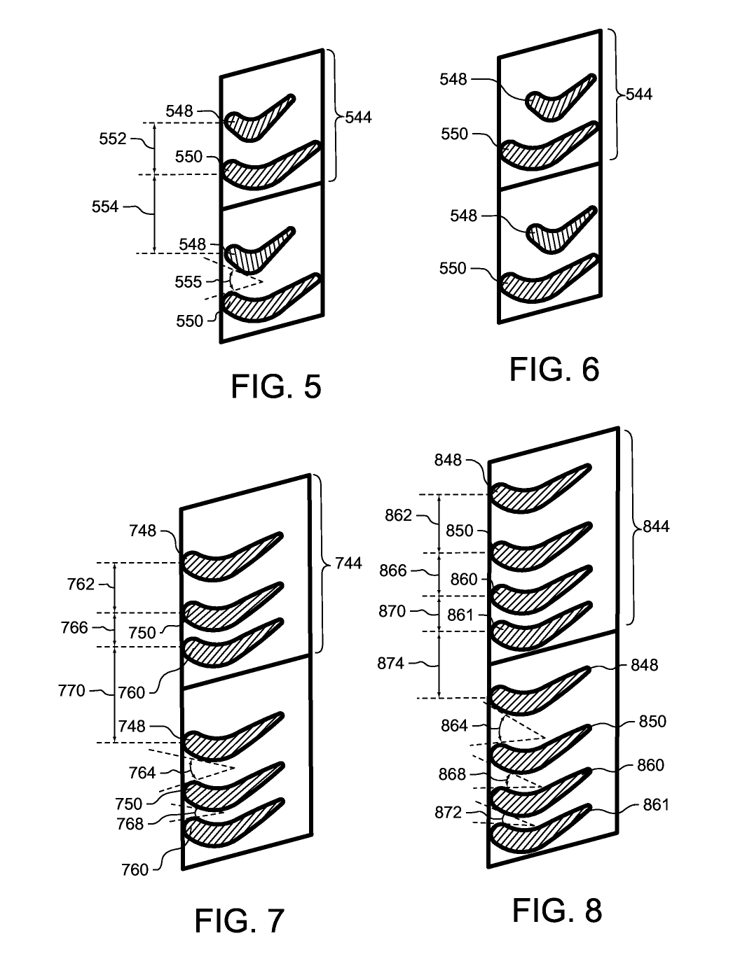

In another alternative embodiment depicted in FIG. 5, vane groupings 544 may be arranged in vane doublets including a first vane 548 and a second vane 550 that has a dissimilar airfoil shape than the first vane 548. The first vane 548 may be separated from the second vane 550 at a first pitch 552. Likewise, each vane grouping 544 may be separated from each other at a second pitch 554 that is dissimilar from the first pitch 552. The first pitch 552 may be less than the second pitch 554. Moreover, the first vane 548 and the second vane 550 may be arranged with respect to each other at a first angle 555. In yet another embodiment depicted in FIG. 6, the vane groupings 544 may be arranged such that the first vane 548 is offset axially downstream from the second vane 550. During engine 10 operation, the vane groupings 544 operate similarly to the vane groupings 44 described above. As such, the blades 34 may be excited at the first frequency 56 each time they pass the first vanes 548 and may be excited at the second frequency 58, which may be dissimilar to the first frequency 56, each time they pass the second vanes 550 due to variation in either pitch, angle, alignment, or any various combination thereof.

In a further alternative embodiment depicted in FIG. 7, vane groupings 744 may be arranged in vane triplets including a first vane 748, a second vane 750, and a third vane 760. Each of the vane groupings 744 may be evenly spaced circumferentially from each other around the flowpath annulus 46. Each of the vanes 748, 750, 760 may have similar or dissimilar airfoil shapes. The first vane 748 may be separated from the second vane 750 at a first pitch 762. The first vane 748 and the second vane 750 may be arranged with respect to each other at a first angle 764. The second vane 750 may be separated from the third vane 760 at a second pitch 766. The second vane 750 and the third vane 760 may be arranged with respect to each other at a second angle 768. Moreover, each vane grouping 744 may be separated from each other at a third pitch 770. The pitches 762, 766, 770 may be dissimilar from each other. The angles 764, 768 may also be dissimilar from each other. The first vane 748, the second vane 750, and the third vane 760 may be axially aligned or may be axially offset from each other. During engine 10 operation, the vane groupings 744 operate similarly to the vane groupings 44 described above. As such, the blades 34 may be excited at different frequencies each time they pass the vanes 748, 750, 760 due to variation in either pitch, angle, alignment, geometry or any various combination thereof.

In still yet another alternative embodiment depicted in FIG. 8, vane groupings 844 may be arranged in vane quadruplets including a first vane 848, a second vane 850, a third vane 860 and a fourth vane 861. Each of the vane groupings 844 may be evenly spaced circumferentially from each other around the flow path annulus 46. Each of the vanes 848, 850, 860, 861 may have similar or dissimilar airfoil shapes. The first vane 848 may be separated from the second vane 850 at a first pitch 862. The first vane 848 and the second vane 850 may be arranged with respect to each other at a first angle 864. The second vane 850 may be separated from the third vane 860 at a second pitch 866. The second vane 850 and the third vane 860 may be arranged with respect to each other at a second angle 868. The third vane 860 may be separated from the fourth vane 861 at a third pitch 870. The third vane 860 and the fourth vane 861 may be arranged with respect to teach other at a third angle 872. Moreover, each vane grouping 844 may be separated from each other a fourth pitch 874. The pitches 862, 866, 870, 874 may be dissimilar from each other. The angles 864, 868, 872 may be dissimilar from each other. The vanes 848, 850, 860, 861 may be axially aligned or may be axially offset from each other. During engine 10 operation, the vane groupings 844 operate similarly to the vane groupings 44 described above. As such, the blades 34 may be excited at different frequencies each time they pass the vanes 848, 850, 860, 861 due to variation in either pitch, angle, alignment, geometry, or any various combination thereof.

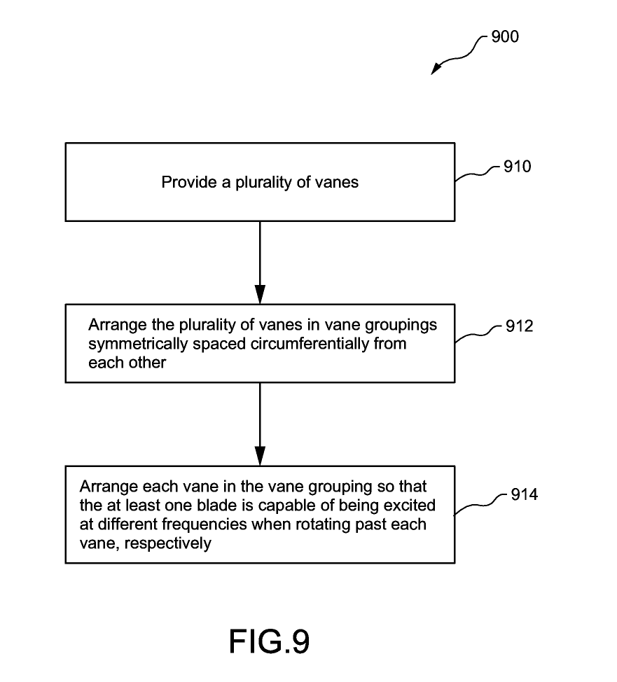

FIG. 9 illustrates a flow chart 900 of a sample sequence of steps which may be performed to reduce vibration on at least one blade in a gas turbine engine. Box 910 shows the step of providing a plurality of vanes in a gas turbine engine. Another step, as illustrated in box 912, is arranging the plurality of vanes in vane groupings symmetrically spaced circumferentially from each other. Box 914 illustrates the step of arranging each vane in the vane grouping so that the at least one blade may be capable of being excited at different frequencies when rotating past each vane, respectively. Each vane in the vane grouping may have a similar airfoil shape. Another step may be arranging each vane with respect to an adjacent vane by one of pitch separating the vanes, angle orientation of the vanes, and axial alignment of the vanes. Each vane in the vane grouping may have dissimilar airfoil shapes. Still a further step may be arranging the vane grouping into vane doublets having a first vane and a second vane. Another step may be arranging the first vane to be capable of exciting the at least one blade at a first frequency and arranging the second vane to be capable of exciting the at least one blade at a second frequency that is dissimilar to the first frequency. The first frequency and the second frequency may be capable of exciting the at least one blade at a first and a second excitation magnitude, respectively, that are less than an excitation magnitude found with a vane assembly having evenly spaced singlet vanes. The at least one blade may be capable of being alternately excited at the first frequency and the second frequency within a revolution to match a peak vibratory stress amplitude with an average vibratory stress amplitude.

While the present disclosure has shown and described details of exemplary embodiments, it will be understood by one skilled in the art that various changes in detail may be effected therein without departing from the spirit and scope of the disclosure as defined by claims supported by the written description and drawings. Further, where these exemplary embodiments (and other related derivations) are described with reference to a certain number of elements it will be understood that other exemplary embodiments may be practiced utilizing either less than or more than the certain number of elements.

### INDUSTRIAL APPLICABILITY

Based on the foregoing, it can be seen that the present disclosure sets forth a vane assembly including vane doublets that alternately excite the passing blades at two different frequencies that are both different from the original symmetric frequency of a symmetric singlet vane assembly. In addition, the excitation magnitude at the first and second frequencies may also be significantly reduced relative to a symmetric singlet vane assembly. The teachings of this disclosure may also be employed such that, transiently, there is no time for the response to build up over half a revolution at one frequency and die down over the other half a revolution at another frequency, as in prior art vane assemblies. Thus, the transient response may be closer to a steady state response which is not the case for conventional asymmetric vane assemblies. Moreover, through the novel teachings set forth above, a single part vane doublet may be produced from a single set of tooling, as opposed to prior art vane assemblies that required two sets of tooling for a first set of vanes spaced at a first spacing of approximately half a flow path annulus and a second set of vanes spaced at a second spacing of the remaining approximately half of the flow path annulus. Additionally, the particular vane doublet spacing described above may be used in any rotating section of a gas turbine engine including a compressor section and a turbine section.

What is claimed is:

1. A vane assembly for a gas turbine engine, the vane assembly comprising:
a plurality of vanes being arranged in vane groupings symmetrically spaced circumferentially from each other, each vane grouping including at least a first and a second vane, the at least first and second vanes being spaced from each other at a first pitch, each vane grouping being spaced from each other at a second pitch, the first pitch being dissimilar from the second pitch.

2. The vane assembly of claim 1, wherein the first pitch is less than the second pitch.

3. The vane assembly of claim 1, wherein the at least first vane has an airfoil shape that is dissimilar to an airfoil shape of the at least second vane.

4. The vane assembly of claim 1, wherein the at least first vane is offset axially downstream from the at least second vane.

5. The vane assembly of claim 4, wherein each vane grouping further includes at least a third vane being spaced from the at least second vane at a third pitch, the third pitch being dissimilar from both the first pitch and the second pitch.

6. A gas turbine engine, the engine comprising:
a compressor;
a combustor downstream of the compressor; and
a turbine downstream of the combustor, one of the compressor and the turbine including a vane assembly, the vane assembly including a plurality of vanes being arranged in vane groupings symmetrically spaced circumferentially from each other, each vane grouping including at least a first and a second vane, the at least first and second vanes being spaced from each other at a first pitch, each vane grouping being spaced from each other at a second pitch, the first pitch being dissimilar from the second pitch.

7. The gas turbine engine of claim 6, wherein the first pitch is less than the second pitch.

8. The gas turbine engine of claim 6, wherein the at least first vane has an airfoil shape that is dissimilar to an airfoil shape of the at least second vane.

9. The gas turbine engine of claim 6, wherein the at least first vane is offset axially downstream from the at least second vane.

10. The gas turbine engine of claim 9, wherein each vane grouping further includes at least a third vane and a fourth vane, the at least third vane being spaced from the at least second vane at a third pitch, the third pitch being dissimilar from both the first pitch and the second pitch, the at least fourth vane being spaced from the at least third vane at a fourth pitch, the fourth pitch being dissimilar from the first through third pitches.

11. The gas turbine engine of claim 6, wherein the compressor includes a plurality of blades associated with the vane assembly, the at least first vane capable of exciting the plurality of blades at a first frequency, the at least second vane capable of exciting the plurality of blades at a second frequency, the first frequency is dissimilar from the second frequency.

12. The gas turbine engine of claim 6, wherein the turbine includes a plurality of blades associated with the vane assembly, the at least first vane capable of exciting the plurality of blades at a first frequency, the at least second vane capable of exciting the plurality of blades at a second frequency, the first frequency is dissimilar from the second frequency.

13. A method of reducing vibration on at least one blade in a gas turbine engine, the method comprising:
providing a plurality of vanes;
arranging the plurality of vanes in vane groupings spaced circumferentially from each other;
arranging each vane in the vane grouping so that the at least one blade is capable of being excited at different frequencies when rotating past each vane, respectively.

14. The method of claim 13, wherein each vane in the vane grouping has a similar airfoil shape.

15. The method of claim 13, wherein the step of arranging each vane in the vane grouping includes arranging each vane with respect to an adjacent vane by one of pitch separating the vanes, angle orientation of the vanes, and axial alignment of the vanes.

16. The method of claim 15, wherein at least one vane in the vane grouping has a dissimilar airfoil shape.

17. The method of claim 13, wherein the step of arranging each vane in the vane grouping includes arranging the vane grouping into vane doublets having a first vane and a second vane.

18. The method of claim 17, further including the step of arranging the first vane to be capable of exciting the at least one blade at a first frequency and arranging the second vane to be capable of exciting the at least one blade at a second frequency that is dissimilar to the first frequency.

19. The method of claim 18, wherein the first frequency and the second frequency is capable of exciting the at least one blade at a first and a second excitation magnitude, respectively, that are less than an excitation magnitude of a vane assembly having evenly spaced singlet vanes.

20. The method of claim 18, wherein the at least one blade is capable of being alternately excited at the first frequency and the second frequency within a revolution to match a peak vibratory stress amplitude with an average vibratory stress amplitude.
